(19) United States
(12) Patent Application Publication
(10) Pub. No.: US 2005/0105140 A1
(43) Pub. Date: May 19, 2005

(54) Communication apparatus and method for controlling same

(75) Inventor: Hiroshi Ozaki, Kanagawa (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/985,776

(22) Filed: Nov. 9, 2004

(30) Foreign Application Priority Data
Nov. 18, 2003 (JP) 2003-388413

(51) Int. Cl. G06F 15/00; H04N 1/00

(52) U.S. Cl. 358/402; 358/1.15

(57) ABSTRACT

A multifunction printer includes a scanner unit, a facsimile unit, an RFID reader/writer unit, a storage unit, and a core unit. The scanner unit reads an image on an original, to which an RFID tag is attached, as image data. The facsimile unit transmits the image data. The RFID reader/writer unit writes identification information, which is used for identifying image data to be transmitted by the facsimile unit, to the RFID tag and reads information stored in the RFID tag. The storage unit stores the identification information written by the RFID reader/writer unit, together with information regarding the transmission of the image data. The core unit performs control so as to report the transmission-related information stored together with the identification information, when the information read by the RFID reader/writer unit matches the identification information stored by the storage unit.

This application claims priority from Japanese Patent Application No. 2003-388413 filed Nov. 18, 2003, which is hereby incorporated by reference herein.

### BACKGROUND OF THE INVENTION

1. Field of the Invention

The present invention relates to a communication apparatus and a method for controlling the same.

2. Description of the Related Art

For communication apparatuses such as facsimile apparatuses, a memory transmission feature and a direct transmission feature have been put to practical use. Specifically, in the memory transmission feature, a communication apparatus reads image data of a set of multiple-page originals and transmits the image data after temporarily storing a certain amount of image data (e.g., image data for one page, image data for several pages, or image data for all pages) in a memory provided in the communication apparatus. In the direct transmission feature, the communication apparatus transmits image-of-original data, obtained by reading images from multiple-page originals, without storing the read data in the memory, i.e., transmits image-of-original data at substantially the same time when reading images from originals. The memory transmission feature, unlike the direct transmission feature, has a certain amount of time difference between the operation for reading images from a set of originals and the operation for transmitting the read images. Thus, when the operation for reading images from the set of originals is completed, the user often leaves the area where the communication apparatus is located, and returns at a later time to check/verify the transmission result(s).

In order to check/verify the transmission result(s), the user typically enters a receipt number or the like at the user interface of the communication apparatus, where the receipt number is issued for a corresponding image-of-original data when the image-of-original data was stored in the memory in conjunction with the transmission of the originals. Alternatively, as disclosed in Japanese Patent Laid-Open No. 2002-281192, the user prints a transmission-result report to check for a corresponding receipt number or the like in the transmission-result report.

However, entering a receipt number or the like through at the communication apparatus' user interface or printing a transmission-result report to check a transmission result with a corresponding receipt number or the like is time-consuming for the user. In addition, when the user forgets the receipt number or the like, he or she cannot check/verify the transmission result(s).

### SUMMARY OF THE INVENTION

The present invention has been made in view of the foregoing, and it is a feature of the present invention is to provide an improved communication apparatus and a method for controlling the same.

In addition, another feature of the present invention is to provide a communication apparatus and a control method therefor which facilitate and ensure checking the transmission result(s) of transmitted image data without a user explicitly entering identification information for identifying the transmitted image data.

One aspect of the present invention provides a communication apparatus. The communication apparatus includes an image reading unit, a transmitting unit, a writing unit, a storage unit, an information reading unit, and a controlling unit. The image reading unit reads an image on an original as image data, where a memory is attached to the original. The transmitting unit transmits the image data read by the image reading unit. The writing unit writes identification information, for identifying the image data to be transmitted by the transmitting unit, to the memory. The storage unit stores the identification information written by the writing unit, together with information related to the transmission of the image data. The information reading unit reads information written in the memory attached to the original. The controlling unit performs control so as to report the transmission-related information stored together with the identification information, when the information read by the information reading unit matches the identification information stored by the storage unit.

Another aspect of the present invention provides a method for controlling a communication apparatus. The method includes an image reading step, a transmitting step, a writing step, a storing step, an information reading step, and a controlling step. In the image reading step, an image on an original, to which a memory is attached, is read as image data. In the transmitting step, the image data read in the image reading step is transmitted. In the writing step, identification information for identifying the image data to be transmitted in the transmitting step is written to the memory attached to the original. In the storing step, the identification information written in the writing step is stored together with information regarding the transmission of the image data. In the information reading step, information written in the memory is read. In the controlling step, control is performed so as to report the transmission-related information stored together with the identification information, when the information read in the information reading step matches the identification information stored in the storing step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate an embodiment of the invention and, together with the description, serve to explain the principles of the invention.

FIG. 1 is a schematic block diagram showing the hardware configuration of a multifunction printer according to the present invention.

FIG. 2 is a cross-sectional view showing the mechanical configuration of a scanner unit and a printer unit of the multifunction printer.

FIG. 3 is a block diagram showing the configuration of a core unit of the multifunction printer.

FIG. 4 is a block diagram of the configuration of an RFID reader/writer unit.

FIG. 5 is a block diagram of the configuration of an RFID tag (i.e., a contactless IC).

FIGS. 6A and 6B are schematic views illustrating a state in which the RFID tag is attached to an original for transmission.

FIG. 7 is a flow chart of memory transmission processing of images of originals.

FIG. 8 is a flow chart of transmission-result checking processing.

### DESCRIPTION OF THE EMBODIMENT

One embodiment for carrying out the present invention is described below with reference to the accompanying drawings.

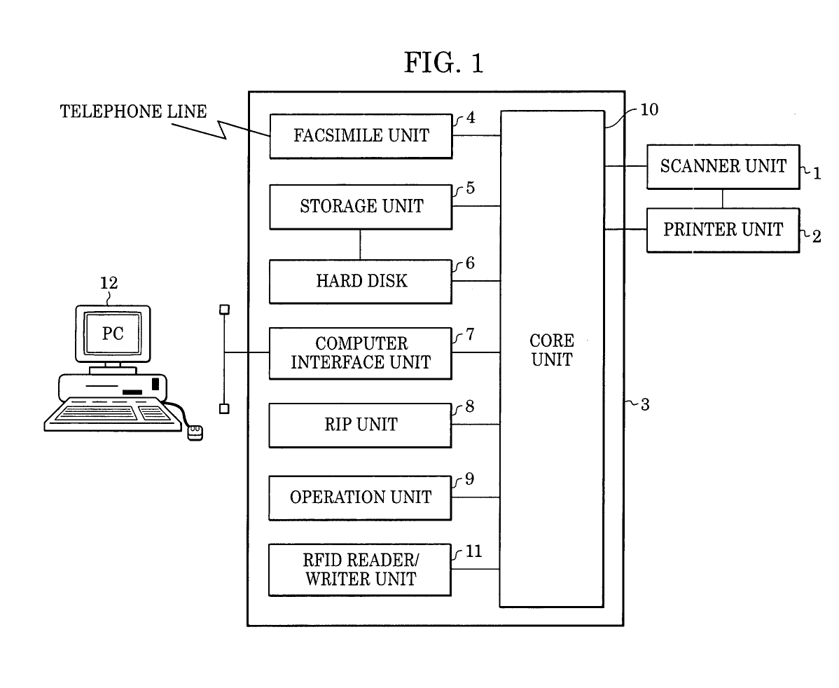

FIG. 1 is a schematic block diagram showing the hardware configuration of a multifunction printer (MFP), i.e., a multifunction apparatus, according to the present invention.

Referring to FIG. 1, a scanner unit 1 photoelectrically converts an image of an original into electronic image data by exposure and scanning. The electronic image data is output to an image input/output controller 3. A printer unit 2 records an image, based on image data output from the image input/output controller 3, onto recording paper. The image input/output controller 3 is connected to the scanner unit 1 and the printer unit 2 and includes a facsimile unit 4, a storage unit 5, a computer interface unit 7, an RIP (raster image processor) unit 8, an operation unit 9, a core unit 10, and an RFID (radio frequency identification) reader/writer unit 11.

The facsimile unit 4 transmits/receives dot-image image data through a telephone line and transfers the received image data to the core unit 10. Image data transmitted to or received from the facsimile unit 4 can be temporarily stored on a hard disk 6, which is connected to the storage unit 5.

The storage unit 5 compresses image data transferred from the core unit 10, and stores the compressed data on the hard disk 6, together with an ID number for searching for the image data. In accordance with an ID number transferred via the core unit 10, the storage unit 5 also searches for compressed image data stored on the hard disk 6, reads the found compressed image data, and decompresses the read image data. The storage unit 5 then transfers the decompressed image data to the core unit 10. In this case, the core unit 10 transfers the image data, transferred from the storage unit 5, to the facsimile unit 4, the computer interface unit 7, and so on.

The computer interface unit 7 provides an interface between a personal computer or work station (PC/WS) 12 and the core unit 10. The computer interface unit 7 may be implemented by a local interface provided for the PC/WS 12 on a one-to-one basis or may be implemented by a network interface. The RIP unit 8 converts code data (i.e., data provided by a page description language) that represents an image and that is transferred from the PC/WS 12 into raster image data that can be processed by the printer unit 2.

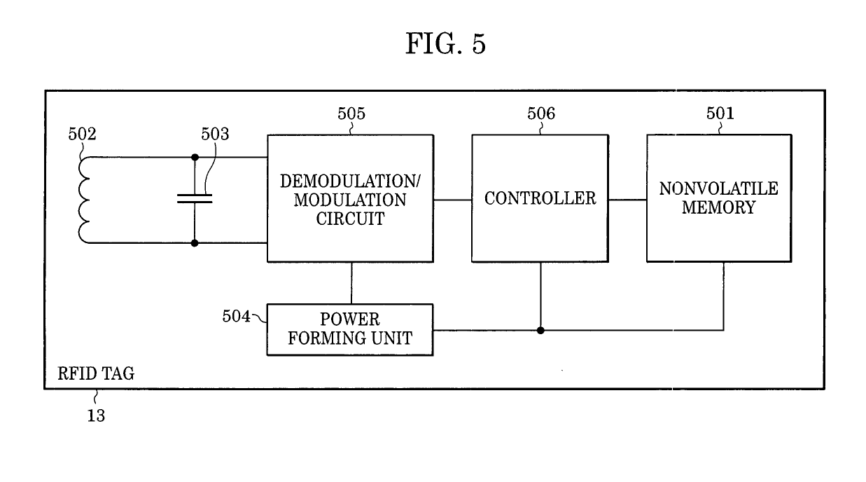

The operation unit 9 includes a touch panel display and hard keys (not shown), for example, to give an instruction for operating the image input/output controller 3, to set the operation thereof, and to display information. The operation unit 9 is provided with the RFID reader/writer unit 11. The RFID reader/writer unit 11 reads/writes data from/to an RFID tag 13 (shown in FIG. 5 and described below) through wireless communication. The RFID tag 13 does not include a power supply, such as a battery, but rather receives its power from radio waves, i.e., electromagnetic waves, emitted by the RFID reader/writer unit 11.

The core unit 10 controls, for example, data flows among the scanner unit 1, the printer unit 2, the facsimile unit 4, the storage unit 5, the computer interface unit 7, the RIP unit 8, the operation unit 9, and the RFID reader/writer unit 11. The core unit 10 is described below in further detail.

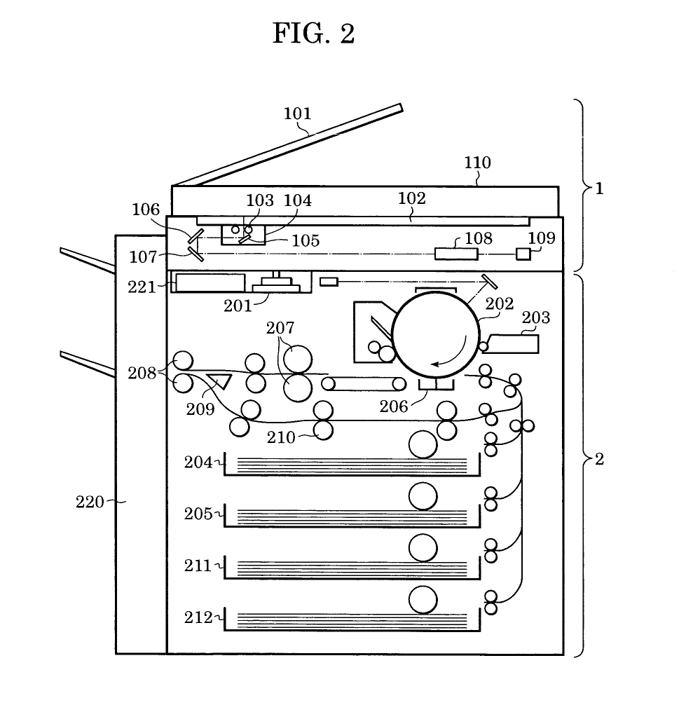

FIG. 2 is a cross-sectional view of the scanner unit 1 and the printer unit 2. An original feeder 101 of the scanner unit 1 can perform an original feed operation for so-called “feed scanning”. During the feed-scanning, originals are sequentially fed to an original reading position on a platen glass 102 sheet by sheet from the first page, images are read from the originals, and originals from which the images are read are sequentially output to a paper output portion 110.

A scanning unit 104, which houses a lamp 103, is stationary at the original reading position in the vicinity of the left end in FIG. 2, when the feed-scanning (i.e., an operation for reading image data from an original while moving the original) is executed. An original being fed at the original reading position is illuminated with light from the lamp 103, so that an image of the original is exposed and scanned. The present invention is also applicable to an apparatus that has no feed-scanning function.

Light reflected from the original during the exposure and scanning is guided to a charge-coupled device, (CCD) image sensor 109 via mirrors 105, 106, and 107, and a lens 108. The light is photo-electrically converted by the CCD image sensor 109, so that electronic image data is output. The image data output from the CCD 109 is subjected to processing, such as analog-to-digital conversion and shading correction, and is then transferred to the core unit 10 of the image input/output controller 3.

A laser driver 221 in the printer unit 2 drives and controls a laser emitter 201, such that the laser emitter emits laser light corresponding to image data output from the core unit 10 of the image input/output controller 3. The laser light emitted from the laser emitter 201 illuminates a photosensitive drum 202, so that an electrostatic latent image corresponding to the laser light is formed on the photosensitive drum 202. The electrostatic latent image formed on the photosensitive drum 202 is converted into a visible image, as a developed image, with a developer supplied from a developer section 203.

Recording paper is fed from one of cassettes 204, 205, 211, or 212 at timing synchronized with the start of laser-light illumination, and the recording paper is conveyed to a transfer section 206. The transfer section 206 transfers the developed image on the photosensitive drum 202 to the recording paper. The recording paper to which the developed image has been transferred is conveyed to a fixing section 207. The developed image is heated and pressed by the fixing section 207, and is thus fixed to the recording paper. After passing through the fixing section 207, during one-sided recording, the recording paper is output to a sorter 220 through ejection rollers 208. When a recording-paper sort feature has been set, the ejected sheets of recording paper are sorted and accommodated by a plurality of bins. When the recording-paper sort function has not been set, the ejected sheets of recording paper are accommodated in the uppermost bin.

During two-sided recording, recording paper is conveyed to the position of the ejection rollers 208 and is then guided to a paper re-feed path 210 by reverse rotations of the ejection rollers 208 and posture switching of a flapper 209. As a result, the recording paper is re-fed to the transfer section 206 at the timing described above.

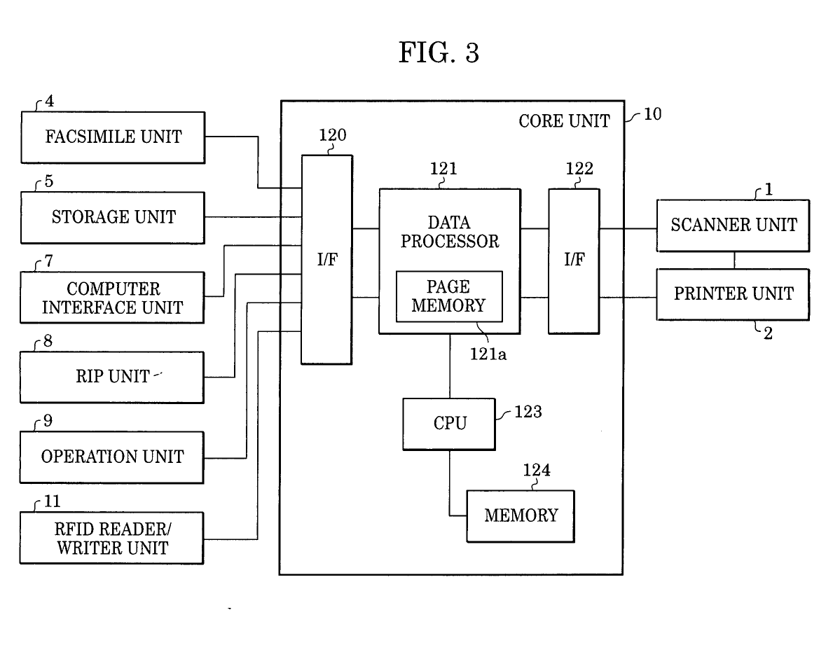

FIG. 3 is a block diagram showing details of the core unit 10. In FIG. 3, the hard disk 6 shown in FIG. 1 is not illustrated but, in practice, is connected to the storage unit 5, as shown in FIG. 1.

Image data output from the scanner unit 1 is transferred to a data processor 121 via an interface (I/F) 122. The data processor 121 performs image processing, such as image-rotation processing and image-zoom processing, and has a page memory 121a, which is capable of storing image data for multiple pages. The image data transferred from the scanner unit 1 to the data processor 121 is temporarily stored in the page memory 121a and is then transferred to the storage unit 5 via an interface (I/F) 120. The transferred image data is compressed by the storage unit 5 and is stored on the hard disk 6.

Code data (i.e., data provided by a page description language) that represents an image and that is input via the computer interface unit 7 is transferred to the data processor 121 via the interface 120 and is further transferred to the RIP unit 8. The RIP unit 8 converts the code data into raster image data. The raster image data is transferred to the data processor 121 and is temporarily stored in the page memory 121a. The raster image data is then transferred to the storage unit 5, is compressed thereby, and is stored on the hard disk 6.

Compressed image data stored on the hard disk 6 is read and decompressed by the storage unit 5. The decompressed image data is temporarily stored in the page memory 121a in the data processor 121 and is then transferred to the printer unit 2, the facsimile unit 4, or the computer interface unit 7.

Alternatively, after various types of image data are input to the data processor 121 and are temporarily stored in the page memory 121a, the data can also be directly transferred to the printer unit 2, the facsimile unit 4, or the computer interface unit 7, before the image data is transferred to the storage unit 5.

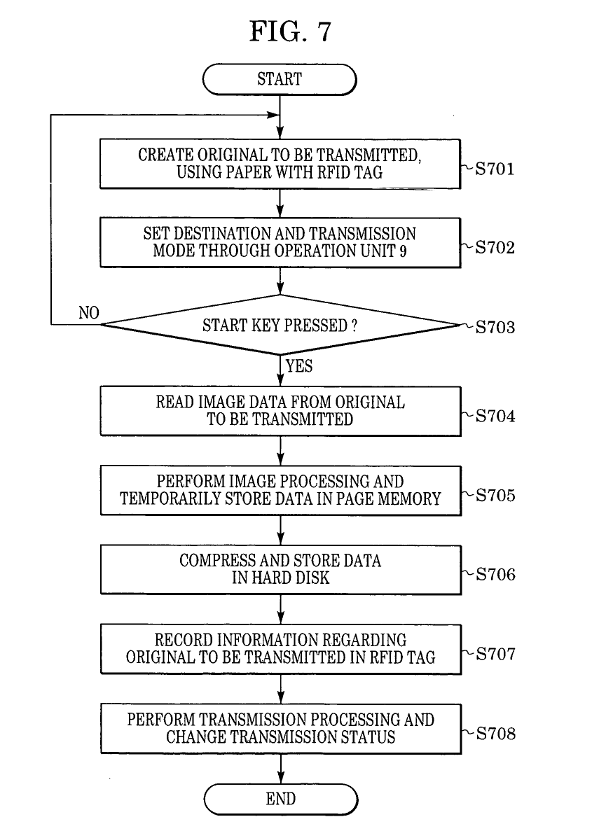

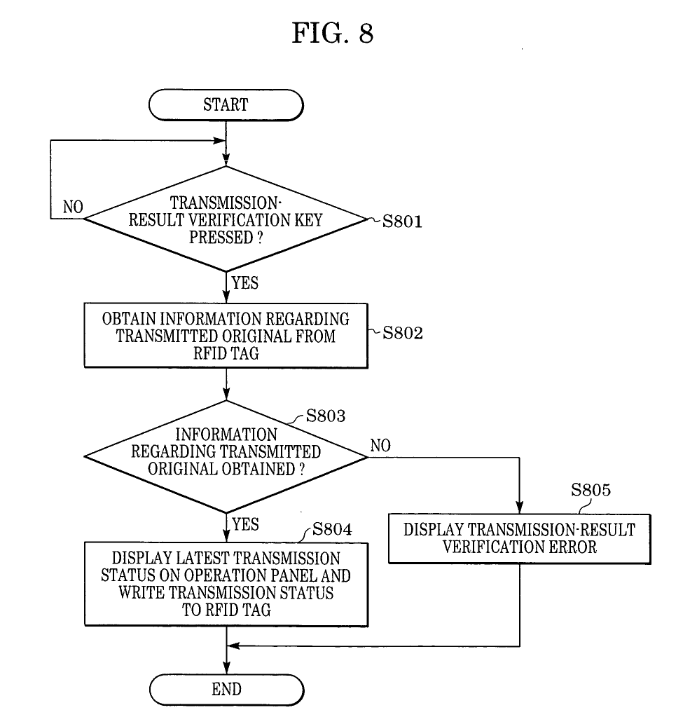

A CPU (central processing unit) 123 controls processing as described above in accordance with a control program stored in a memory 124, a control command input from the operation unit 9, a control command transferred together with image data, and so on. The memory 124 is also used as a work area for the CPU 123. The memory 124 also stores an application program corresponding to flow charts shown in FIGS. 7 and 8.

As described above, with the core unit 10 functioning as a central unit, this multifunction printer performs processing for multiple functions, such as reading of an image of an original, printing, receiving/transmitting, or storing of image data, and inputting/outputting to/from the computer via the data processor 121 and the storage unit 5.

Although the above description is an example in which image data is input/output via the hard disk 6 of the storage unit 5, the use of the hard disk 6 is not essential. For example, image data may be input/output using a portion of the page memory 121a of the data processor 121, rather than the hard disk 6. In addition, a finisher, other than the sorter 220, can also be used.

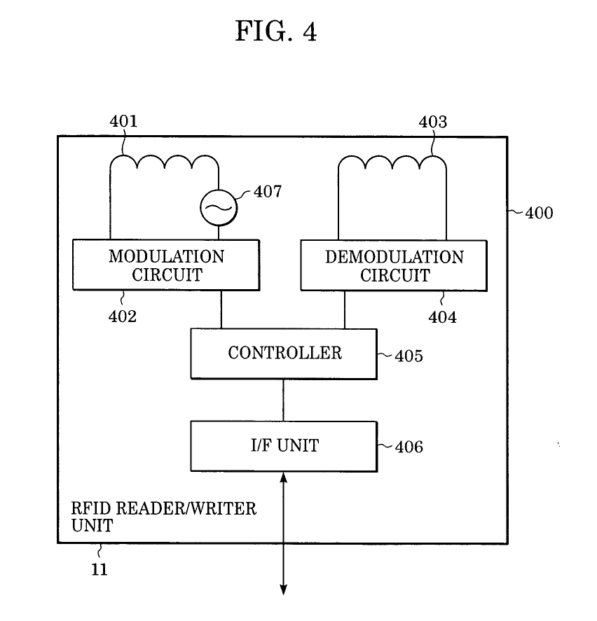

FIG. 4 is a block diagram showing the configuration of the RFID reader/writer unit 11. The RFID reader/writer unit 11 includes a transmitting antenna unit 401, a modulation circuit 402, a receiving antenna unit 403, a demodulation circuit 404, a controller 405, and an interface (I/F) unit 406. The transmitting antenna unit 401 transmits radio signals. The modulation circuit 402 modulates data signals to be transmitted from the transmitting antenna unit 401. The receiving antenna unit 403 receives radio signals. The demodulation circuit 404 demodulates the radio signals received by the receiving antenna unit 403. The I/F unit 406 communicates with equipment, (i.e., the core unit 10) as well as the RFID tag 13. The controller 405 controls the transmitting antenna unit 401, the modulation circuit 402, the receiving antenna unit 403, the demodulation circuit 404, and the I/F unit 406. The transmitting antenna unit 401 is connected to an alternating-current power supply 407 for constantly emitting radio waves for the above-noted power generation.

In accordance with an instruction from the core unit 10, the controller 405 uses the modulation circuit 402 to modulate data to be transmitted and radio waves for supplying power and to transmit the resulting radio waves via the transmitting antenna unit 401. The controller 405 can cause the demodulation circuit 404 to demodulate radio signals received by the receiving antenna unit 403 and to then convert the resulting radio signals into signals that can be processed as data signals.

FIG. 5 is a block diagram showing the configuration of the RFID tag 13. The RFID tag 13 is also called a contactless IC chip or a data carrier and is capable of communicating with the RFID reader/writer unit 11 wirelessly (i.e., in a contactless manner).

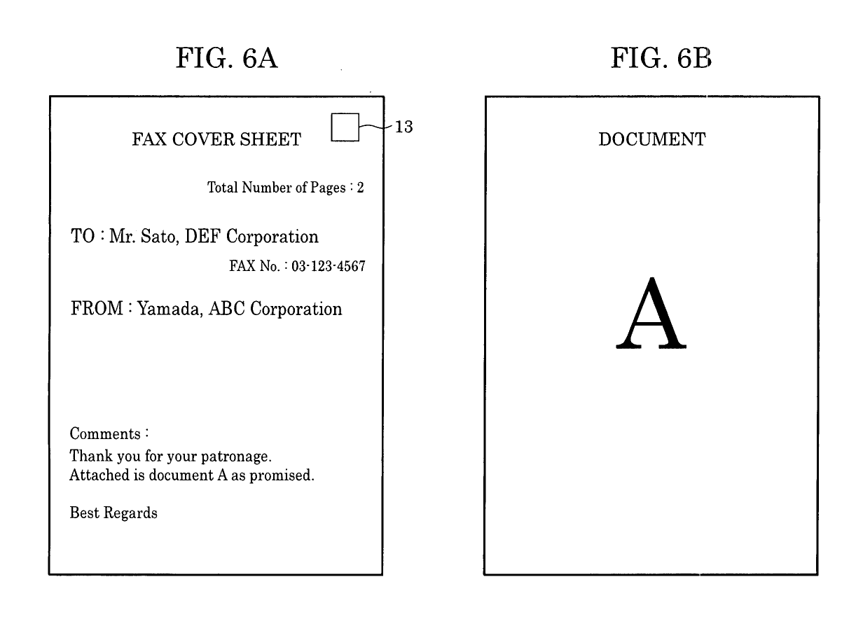

In the present embodiment of the present invention, an ultra-small μ-chip RFID tag can preferably be used as the RFID tag 13. The RFID tag 13 is integrated (embedded) into, for example, a cover sheet (as shown in FIG. 6A) for originals (e.g., document A shown in FIG. 6B) for facsimile transmission. The RFID tag 13, however, may take a label form attachable to an original. When the RFID tag 13 having such a form is attached to an original (i.e., paper), it is desired that the RFID tag 13 be attached to the margin, such as one of the four corners or edge portions of the original. Further, since an original to which the RFID tag 13 has been attached is more expensive than ordinary paper, it is desired that paper to which the RFID tag 13 is attached is used for only one sheet of a set of originals to be transmitted. In this case, in order to expedite transmission-result checking work described below, it is desired that paper to which the RFID tag 13 is attached be used for a first page or a last page in the case of a multi-page original.

As shown in FIG. 5, the RFID tag (i.e., contactless IC) 13 includes a nonvolatile memory 501, an antenna unit 502 for transmitting/receiving radio waves, a resonant capacitor section 503, a power forming unit 504 for rectifying and smoothing electrical current, a demodulation/modulation circuit 505 for demodulating/modulating radio waves, and a controller 506. The RFID tag 13 does not include a power supply, such as a battery, but rather, receives power from radio waves supplied from the RFID reader/writer unit 11.

A combination of the antenna unit 502 and the resonant capacitor section 503 provides a resonant circuit. As previously discussed, RFID reader/writer unit 11 constantly generates radio waves (i.e., alternating-current magnetic fields) for power generation. Holding the RFID tag 13 toward the RFID reader/writer unit 11 causes the resonant circuit in the RFID tag 13 to induce current by electromagnetic induction. The induced current is output to the power forming unit 504, which then rectifies and smoothes the induced current to generate power having a predetermined voltage. The power is supplied to the nonvolatile memory 501, the controller 506, and the demodulation/modulation circuit 505.

The RFID reader/writer unit 11 also transmits radio signals, associated with various types of data, simultaneously with the radio signals for power generation. The radio signals associated with data are demodulated by the demodulation/modulation circuit 505. Under the control of the controller 506, the demodulated radio signals are written to the nonvolatile memory 501. The controller 506 also reads data from the nonvolatile memory 501, causes the demodulation/modulation circuit 505 to modulate the read data, and causes the modulated data to be transmitted via the antenna unit 502 as radio signals.

Memory transmission processing for an image of an original is described next with reference to the flow chart shown in FIG. 7.

First, in step S701, a user creates an original to be transmitted by using a sheet of paper to which the RFID tag 13 is attached for at least one sheet of a set of originals to be transmitted. In this case, the number of originals to be transmitted may be one. Next, in step S702, the user places the set of originals including the original having the RFID tag 13 onto the original feeder 101 of the scanner unit 1 and operates the operation unit 9 to set destination information (e.g., a telephone (facsimile) number) and a transmission mode. Flow then proceeds to step S703, where a determination is made whether the user has pressed a start button (not shown) located on the operation unit 9.

If, in step S703, it is determined that the user has not pressed the start button, flow returns to step S701. If, in step S703 it is determined that the user has pressed the start button, then flow proceeds to step S704, where the CPU 123 causes the scanner unit 1 to read images of the originals and causes the read image-of-original data to be transferred to the data processor 121 via the interface 122.

In step S705, the CPU 123 causes the data processor 121 to execute image processing, such as rotation processing and zoom processing, on the image-of-original data and to temporarily store the resulting data in the page memory 121a. Next, in step S706, the CPU 123 issues an instruction to the data processor 121 such that the image-of-original data temporarily stored in the page memory 121a is transferred to the storage unit 5 via the interface 120. In this case, in accordance with the instruction from the CPU 123, the storage unit 5 compresses the transferred image-of-original data and stores the compressed data on the hard disk 6.

Next, in step S707, the CPU 123 issues an instruction to the storage unit 5 such that the compressed image-of-original data stored on the hard disk 6 is transferred to the facsimile unit 4 via the interface 120. The CPU 123 also issues an instruction to the RFID reader/writer unit 11 such that identification information, which serves as a transmission job ID, for identifying the set of originals to be transmitted, i.e., a transmission job, is recorded to the RFID tag 13 attached to the original to be transmitted. The identification information includes a receipt number for the transmission job, source and destination information (e.g., a telephone (facsimile) number), and reception date and time or transmission date and time.

As the identification information for identifying a transmission job, not all of the receipt number of the transmission job, source and destination information (e.g., a telephone (facsimile) number), and reception date and time or transmission date and time need to be recorded to the RFID tag 13. For example only the receipt number of the transmission job may be recorded. There is also no need to record the receipt number of the transmission job to the RFID tag 13, and thus, for example, image data of the heading portion of a first page of originals to be transmitted or image data of a portion frequently used in a set of originals to be transmitted can be recorded. In short, at least one piece of any types of identification information that allows a set of originals for transmission, i.e., originals associated with one transmission job, to be discriminated from originals associated with another transmission job is recorded to the RFID tag 13 as a transmission job ID.

The above description has been given based on the premise that, when the transfer of image-of-original data is started to the facsimile unit 4, a set of originals for transmission is still left discharged in the paper output portion 110 of the original feeder 101, i.e., the user has not taken the set of originals for transmission away from the paper output portion 110 yet. Thus, on this premise, a corresponding transmission job ID is recorded to the RFID tag 13 of the originals for transmission, at a point of time when the transfer of image-of-original data is started to the facsimile unit 4, as described above. However, for example, in connection with the processing speed or the like of the system, a set of originals for transmission could be taken away from the paper output portion 110 at a point of time when the data transfer is started. In such a case, a corresponding transmission job ID may be recorded to the RFID tag 13 of the originals for transmission, at another point of time, for example, at a point when the start key is pressed or the reading of the set of originals to be transmitted is completed.

The CPU 123 automatically generates the receipt number (i.e., transmission job ID) of a transmission job and supplies the receipt number to the RFID reader/writer unit 11. The CPU 123 supplies the telephone (facsimile) number, input in step S702, to the RFID reader/writer unit 11. The CPU 123 obtains the reception date and time or transmission date and time from a clock circuit (not shown) and supplies the information to the RFID reader/writer unit 11. Further, when the name of a transmitting person and the name of a destination are pre-registered through a telephone book function or the like so as to correspond to the telephone (facsimile) number, the name of the transmitting person and the name of the destination may also be recorded to the RFID tag 13 of an original.

Returning to the flow of FIG. 7, in accordance with an instruction from the CPU 123, the facsimile unit 4 attempts to establish a line connection with a destination. When successfully connected, the facsimile unit 4 encodes compressed image-of-original data, transferred from the storage unit 5, into facsimile signals and transmits the facsimile signals. In this case, for each transmission job ID, the facsimile unit 4 stores the latest transmission status information in an internal memory (not shown). Examples of the latest transmission status information include transmission-standby information, transmission-in-progress information, transmission-completion information, and transmission-failure information. Thus, the facsimile unit 4 appropriately updates and manages the transmission status information in accordance with the progress of memory transmission.

When transmission date and time has been set in step S702, the transfer processing in step S707 and the transmission processing in S708 are executed under the control of the CPU 123 upon the arrival of the pre-set transmission date and time.

Transmission-result checking processing is described next with reference to the flow chart shown in FIG. 8. First, in step S801, a transmitted original having the RFID tag 13 is held toward the RFID reader/writer unit 11 provided at the operation unit 9 and a transmission-result verification key (not shown) provided on the operation unit 9 is pressed. Then, in step S802, the CPU 123 issues an instruction to the RFID reader/writer unit 11 such that information recorded in the RFID tag 13 attached to the transmitted original is read.

Next, in step S803, the CPU 123 determines whether or not the RFID reader/writer unit 11 reads, from the RFID tag 13, at least a transmission job ID that is the same as one held by the facsimile unit 4. When the read transmission job ID is different from the held transmission job ID, flow proceeds to step S805, where an error message indicating a failure in the transmission result verification, for example, “the transmission job is not found”, is displayed on the touch panel provided at the operation unit 9.

On the other hand, when the transmission job ID read from the RFID tag 13 attached to the transmitted original is the same as a transmission job ID held by the facsimile unit 4, flow proceeds to step S804, where the CPU 123 causes transmission status information corresponding to the transmission job ID to be read from the facsimile unit 4 and causes the transmission status information to be displayed on the touch panel display. Further, the CPU 123 causes the RFID reader/writer unit 11 to write the transmission status information (i.e., the transmission status and the transmission result) to the RFID tag 13 attached to the transmitted original held toward the RFID reader/writer unit 11.

In steps S804 and S805, the user can be notified of the transmission result by means of printing a message or outputting voice or sound, rather than displaying a message as noted above. Further, in step S804, in order to allow the user to check whether or not transmission has been made to a desired destination, the user may be notified of not only the transmission status information but also the facsimile number of the destination and so on.

As described above in the present embodiment, paper to which the RFID tag 13 is attached is used for at least one sheet of a set of originals to be transmitted. When the scanner unit 1 reads image data of the set of originals, the RFID reader/writer unit 11 records the transmission job ID to the RFID tag 13 and the facsimile unit 4 manages the transmission result of image-of-original data corresponding to the transmission job ID. Thereafter, when the transmitted original to which the RFID tag 13 is attached is held toward the RFID reader/writer unit 11, the transmission result of the transmission job is automatically verified and the user is notified of the verification result.

Thus, unlike the conventional approach, the present embodiment can eliminate the need for entering a receipt number or the like of a transmission job to check a transmission result or the need for printing a transmission result report to check a transmission result with a corresponding receipt number or the like of a transmission job. This allows for simple checking of a transmission result. In addition, in the present embodiment, not only is the transmission job ID recorded to the RFID tag of originals for transmission, but source and destination information (e.g., telephone (facsimile) number, the name of a transmitting person, and the name of a destination] are also recorded. Thus, when transmitted originals are managed on a personal computer or the like, time and effort for obtaining those pieces of information can be eliminated, thereby facilitating the management work of the transmitted originals. Further, this arrangement allows the user to easily and readily check whether or not transmission has been successively delivered to a desired destination.

The present invention is not limited to the above-described embodiment. For example, when a set of originals contains classified information, such as company secret information or department secret information, paper to which the RFID tag is attached can be used for each of the originals to be transmitted. In such a case, when the originals are read, the identification information of each original can be recorded to the corresponding RFID tag of each original for transmission. Further, for each transmitted original, a transmission result can be managed and the user can be notified of the transmission result.

An RFID tag in which predetermined identification data, such as identification-of-original data, is pre-stored can also be attached to an original to be transmitted. In such a case, the identification data is read, by the RFID reader/writer unit, from the RFID tag of the original, and transmission-result information, including destination information, for image data for the original corresponding to the identification data or a set of originals including the original is managed. In accordance with the identification data recorded in the RFID tag, the managed transmission-result information can be searched for and the user can be notified of the transmission-result information.

The present invention is also applicable to multifunction printers or facsimile apparatuses that have no memory transmission feature. In such a case, when the user moves away from that apparatus after setting an original or originals for transmission on the apparatus, entering a facsimile number, and pressing the start button, the user can later check whether the transmission has been delivered to a desired destination, without having to enter a receipt number or the like. Moreover, the user can easily and readily perform the checking.

The above-described objects of the present invention can also be achieved by supplying a storage medium or recording medium storing software-program code for realizing the features of the illustrated embodiment to a system or apparatus so that a computer (or CPU or MPU) of the system or apparatus reads and executes the program code.

In such a case, the program code that is read from the storage medium achieves the features of the illustrated embodiment and the storage medium in which the program code is stored also constitutes a part of the present invention. Further, not only is the program code that is read from the computer executed to achieve the features of the illustrated embodiment, but also an operating system (OS) or the like that is running on the computer may perform part or all of the actual processing in accordance with instructions of the program code to achieve the features of the illustrated embodiment. Such an arrangement is also covered by the present invention.

Additionally, after the program code that is read from the storage medium is stored in a memory that is provided in a plug-in card inserted into the computer or an expansion unit connected to the computer, a CPU or the like that is provided in the plug-in card or the expansion unit may perform part or all of the actual processing in accordance with instructions of the program code to achieve the features of the illustrated embodiment. When the present invention is applied to storage medium, program code corresponding to the flow charts shown in FIGS. 7 and 8 and as described above is stored in the storage medium.

As many apparently widely different embodiments of the present invention can be made without departing from the spirit and scope thereof, it is to be understood that the invention is not limited to the specific embodiment thereof except as defined in the appended claims.

1. A communication apparatus comprising:
an image reading unit configured to read an image on an original as image data, the original having a memory attached thereto;
a transmitting unit configured to transmit the image data read by the image reading unit;
a writing unit configured to write identification information, for identifying image data to be transmitted by the transmitting unit, to the memory;
a storage unit configured to store the identification information written by the writing unit, together with information related to the transmission of the image data;
an information reading unit configured to read information written in the memory; and
a controlling unit configured to perform control so as to report the transmission-related information stored together with the identification information, when the information read by the information reading unit matches the identification information stored by the storage unit.

2. The communication apparatus according claim 1, further comprising a converting unit configured to convert the image data read by the image reading unit into facsimile data, wherein the transmitting unit transmits the facsimile data to a facsimile apparatus.

3. The communication apparatus according to claim 2, further comprising an image accumulating unit configured to accumulate the image data read by the image reading unit, wherein after the image accumulating unit accumulates a predetermined amount of image data for multiple-page originals, the transmitting unit transmits the facsimile data corresponding to the image data.

4. The communication apparatus according to claim 1, wherein the memory is attached to at least one of multiple-page originals and the writing units writes the identification information for identifying image data transmitted by the transmitting unit into the memory.

5. The communication apparatus according to claim 1, wherein the transmission-related information comprises at least one of information indicating that the image data is not transmitted, information indicating that the transmission of the image data is completed, information indicating a failure in the transmission of the image data, information for identification of the communication apparatus, and information regarding a destination of the transmitting unit.

6. The communication apparatus according to claim 1, wherein the writing unit writes the identification information while the image reading unit reads the image on the original.

7. The communication apparatus according to claim 1, wherein the writing unit writes the identification information after the image reading unit reads the image on the original.

8. The communication apparatus according to claim 1, wherein, when the information read by the information reading unit does not match the identification information stored by the storage unit, the controlling unit performs control so as to report that no transmission-related information corresponding to the information read by the information reading unit is stored by the storage unit.

9. The communication apparatus according to claim 1, wherein, when the information read by the information reading unit matches the identification information stored by the storage unit, the writing unit writes the transmission-related information stored together with the identification information into the memory.

10. The communication apparatus according to claim 1, wherein, when the information read by the information reading unit matches the identification information stored by the storage unit, the controlling unit performs control so as to cause the transmission-related information stored together with the identification information to be displayed at a display unit.

11. The communication apparatus according to claim 1, further comprising an image forming unit configured to form an image onto recording paper, wherein, when the information read by the information reading unit matches the identification information stored by the storage unit, the controlling unit performs control so as to cause the image forming unit to form an image for the transmission-related information stored together with the identification information onto the recording paper.

12. The communication apparatus according claim 1, wherein the writing unit is capable of writing the identification information while being out of contact with the memory, and the information reading unit is capable of reading the information while being out of contact with the memory.

13. A method for controlling a communication apparatus, the method comprising:
an image reading step of reading an image on an original as image data, the original having a memory attached thereto;
a transmitting step of transmitting the image data read in the image reading step;
a writing step of writing identification information, for identifying image data to be transmitted in the transmitting step, to the memory;
a storing step of storing the identification information written in the writing step, together with information regarding the transmission of the image data;
an information reading step of reading information written in the memory; and
a controlling step of performing control so as to report the transmission-related information stored together with the identification information, when the information read in the information reading step matches the identification information stored in the storing step.

14. The method according claim 13, further comprising a converting step of converting the image data read in the image reading step into facsimile data, wherein in the transmitting step, the facsimile data is transmitted to a facsimile apparatus.

15. The method according to claim 14, further comprising an image accumulating step of accumulating the image data read in the image reading step, wherein after a predetermined amount of image data for multiple-page originals is accumulated in the image accumulating step, the facsimile data corresponding to the image data is transmitted in the transmitting step.

16. The method according to claim 13, wherein the memory is attached to at least one of multiple-page originals and, in the writing step, the identification information for identifying image data transmitted in the transmitting step is written to the memory.

17. The method according to claim 13, wherein the transmission-related information comprises at least one of information indicating that the image data is not transmitted, information indicating that the transmission of the image data is completed, information indicating a failure in the transmission of the image data, information for identification of the communication apparatus, and information regarding a destination set in the transmitting step.

18. The method according to claim 13, wherein in the writing step, the identification information is written while the image on the original is read in the image reading step.

19. The method according to claim 13, wherein in the writing step, the identification information is written after the image on the original is read in the image reading step.

20. The method according to claim 13, wherein, when the information read in the information reading step does not match the identification information stored in the storing step, control is performed in the controlling step so as to report that no transmission-related information corresponding to the information read in the information reading step is stored in the storing step.

21. The method according to claim 13, wherein, when the information read in the information reading step matches the identification information stored in the storing step, the transmission-related information stored together with the identification information is written to the memory in the writing step.

22. The method according to claim 13, wherein, when the information read in the information reading step matches the identification information stored in the storing step, control is performed in the controlling step so as to cause the transmission-related information stored together with the identification information to be displayed at a display unit.

23. The method according to claim 13, further comprising an image forming step of forming an image onto recording paper, wherein, when the information read in the information reading step matches the identification information stored in the storing step, control is performed in the controlling step so as to cause an image for the transmission-related information stored together with the identification information to be formed on the recording paper in the image forming step.

24. The method according claim 13, wherein in the writing step, the identification information is writable without contact with the memory, and in the information reading step, the information is readable without contact with the memory.
